(19) United States
(12) Patent Application Publication
(10) Pub. No.: US 2026/0295590 A1
(43) Pub. Date: Oct. 1, 2026

(54) A METHOD OF FORMING ARRAYS OF DROPLETS

(71) Applicant: NUCLERA LTD, Cambridge (GB)

(72) Inventors: Michal Jan Horka, Cambridge (GB); Sumit Kalsi, Cambridge (GB); Andreas Michael Waeber, Cambridge (GB)

(21) Appl. No.: 18/996,463

(22) PCT Filed: Aug. 1, 2023
(86) PCT No.: PCT/GB2023/052029

§ 371 Date: Jan. 17, 2025

(30) Foreign Application Priority Data
Aug. 1, 2022 (GB) 2211204.9

(51) Int. Cl. B01L 3/00

(52) U.S. Cl. CPC B01L 3/502792; B01L 2200/0673; B01L 2300/0645; B01L 2300/0816; B01L 2300/0864; B01L 2400/0427

(57) ABSTRACT

A method for forming an array of droplets by splitting droplets into smaller droplets using lateral movements. The method involves taking one or more droplets and splitting in multiple dimensions to form an array of smaller evenly sized droplets.

### FIELD OF THE INVENTION

This invention is in the field of fluid electrokinetics: Electrowetting-on-dielectric (EWoD) and Dielectrophoresis (DEP); and the methods and devices using these phenomena. The invention relates to methods for efficiently forming arrays of evenly sized droplets via droplet splitting using lateral movements that enhances the radius of curvature on the edges away from the pinch off point, to ensure an even split.

### BACKGROUND

The manipulation of droplets by the application of electrical potential can be achieved on electrodes covered with an insulator or a dielectric or a series of insulators or dielectrics. Droplet manipulation as a result of an applied electrical potential is known as electrowetting. Electrokinesis occurs as result of a non-uniform electric field that influences the hydrostatic equilibrium of a dielectric liquid (dielectrophoresis or DEP) or a change in the contact angle of the liquid on solid surface (electrowetting-on-dielectric or EWoD). DEP can also be used to create forces on polarizable particles to induce their movement. The electrical signal can be transmitted to a discrete electrode, a transistor, an array of transistors, or a sheet of semiconductor film whose electrical properties can be modulated by an optical signal.

EWoD phenomena occur when droplets are actuated between two parallel electrodes covered with a hydrophobic insulator or dielectric. The electric field at the electrode-electrolyte interface induces a change in the surface tension, which results in droplet motion as a result of a change in droplet contact angle. The electrowetting effect can be quantitatively treated using Young-Lippmann equation:

$$cos θ - cos {θ}_{0} = ( 1 / {2}_{Y} LG ) c \cdot {V}^{2}$$

where θ₀ is the contact angle when the electric field across the interfacial layer is zero, γLG is the liquid-gas tension, c is the specific capacitance (given as εᵣ. ε₀/t, where εᵣ is dielectric constant of the insulator/dielectric, co is permittivity of vacuum, t is thickness) and V is the applied voltage or electrical potential. The change in contact angle (inducing droplet movement) is thus a function of surface tension, electrical potential, dielectric thickness, and dielectric constant.

When a droplet is actuated by EWOD, there are two opposing sets of forces that act upon it: an electrowetting force induced by electric field and resistant forces that include the drag forces resulting from the interaction of the droplet with filler medium and the contact line friction. The minimum voltage applied to balance the electrowetting force with the sum of all drag forces (threshold voltage) is variably determined by the thickness-to-dielectric contact ratio of the insulator/dielectric, (t/εᵣ)^{1/2}. Thus, to reduce actuation voltage, it is required to reduce (t/εᵣ)^{1/2} (i.e., increase dielectric constant or decrease insulator/dielectric thickness). To achieve low voltage actuation, thin insulator/dielectric layers must be used. However, the deposition of high quality thin insulator/dielectric layers is a technical challenge, and these thin layers are easily damaged before the desired electrowetting contact angle is large enough to drive the droplet is achieved. Most academic studies thus report the use of much higher voltages >100 V on easily fabricated, thick dielectric films (>3 μm) to effect electrowetting.

High voltage EWoD-based devices with thick dielectric films, however, have limited industrial applicability largely due to their limited droplet multiplexing capability. The use of low voltage devices including thin-film transistors (TFT) and optically-activated amorphous silicon layers (a-Si) have paved the way for the industrial adoption of EWoD-based devices due to their greater flexibility in addressing electrical signals in a highly multiplex fashion. The driving voltage for TFTs or optically-activated a-Si are low (typically <15 V). The bottleneck for fabrication and thus adoption of low voltage devices has been the technical challenge of depositing high quality, thin film insulators/dielectrics. Hence there has been a particular need for improving the fabrication and composition of thin film insulator/dielectric devices.

The inventors wished to implement a method for producing an ordered array having a large number of evenly sized droplets. Previous approaches involve using TFT high-density arrays and individually placing each desired droplet at the desired locations, thereby requiring dispensing of multiple droplets to exact locations. Previously reported methods of splitting droplets involved splitting droplets individually and then moving them to exact location. Alternative methods involve splitting droplets in sequence rather than simultaneously, or repeatedly dispensing multiple droplets from a larger reservoir. Such methods are inefficient at producing large numbers of droplets and the droplets vary in size.

WO2007/147568/U.S. Pat. No. 8,409,417B2 discloses conventional methods of splitting droplets by pulling the ends apart to form an increasingly narrow neck, for example FIG. 8A-8C. Such methods split droplets along the longest axis and does not give an evenly distributed volume of material between the two droplets. Such methods can only split droplets into two volumes.

EP1643231 discloses methods for manipulating liquids on devices. Certain embodiments disclosed involve the stretching of droplets in order to promote mixing, for example as shown on [0065] FIG. 27, which shows a divided electrode pattern having a stirring region. The application does not describe the preparation or handling or large numbers of droplets.

WO2021041709 describes further systems for droplet manipulation. The application describes many potential applications that could be performed on droplets, but does not describe specific details of how droplets are moved and handled.

EP2884272 describes the known method of producing a train of droplets from a larger reservoir. Such a method of forming an array of droplets by removal of single droplets is inefficient in both time, space and reagent use.

Alternatively, in traditional microfluidics literature, physical structures such as wells or beads are usually needed to immobilize/anchor the droplets. Other non-flow applications involve various microstructures or meshes, which would greatly increase the cost of device manufacturing.

### SUMMARY OF THE INVENTION

Described herein is a method for the rapid generation of ordered droplet arrays using repeated droplet division to ensure evenly sized droplets. The method can rapidly generate arrays of large numbers of droplets with a level of variation in size. The benefit of the present invention is that it greatly reduces the time to create a large ordered array of uniform droplets by using an initial large droplet dispense followed by several steps of splitting. Such techniques reduce the physical area needed to split a large number of droplets. By carefully spacing the droplets initially it is possible to reduce movement beyond the split operation, allowing for the array to be generated in the shortest time possible and within the original space occupied by the larger droplets. Multiple starting volumes may be split using different numbers of steps and sizes in order to create a large number of discrete reagent volumes rapidly on the device.

An important criterion for splitting a droplet requires a large contact angle change (function of dielectric thickness, voltage applied, and surface tension), a small channel gap, or a large radius at the end regions of the droplet (dependent on the size of the electrode). Previous droplet splitting methods involve pulling on the droplet such that a neck is formed as the two ends are pulled apart. The splitting occurs via a mechanism of pulling to form a ‘figure of 8’ when eventually splits into two parts. This stretching does not result in an even split as the surface tension of the droplet tries to pull the droplet back together. The splitting is particularly uneven where the liquid shapes are square or rectangular shapes caused by the electrodes on the array being square. Rather than stretching the droplet, the inventors herein have appreciated that a more even split is obtained if the droplet is moved laterally (i.e. the ends slide along an axis perpendicular to the longest axis of the droplet). The lateral movement increases the radius of curvature at the distal end of the laterally moving droplet edges and thereby promotes an evenly sized split.

### DETAILED DESCRIPTION

Described is a method for forming an array of droplets on an electrokinetic device, the method comprising taking one or more first droplets and repeatedly splitting the one or more first droplets into smaller droplets, wherein the splitting occurs in two directions on the electrokinetic device.

Disclosed is a method for forming a plurality of droplets on an electrokinetic device, the method comprising taking first droplets and splitting the droplets into multiple evenly sized smaller droplets by moving the droplets in opposing lateral directions. The splitting occurs by moving the droplets along an axis perpendicular to the longest axis of the droplets. The lateral movement is at 90 degrees to the elongated axis such that at least one of the ends of the droplet move perpendicular to the elongated axis.

Disclosed is a method for forming a plurality of droplets on an electrokinetic device, the method comprising taking first droplets and splitting the droplets into multiple evenly sized smaller droplets by moving the droplets in opposing lateral directions, wherein the first droplets are elongated before splitting and the lateral movement is at 90 degrees to the elongated axis such that the ends of the droplet move perpendicular to the elongated axis.

The droplets may be rectangular. Once split, the droplets can be split into smaller rectangles or squares. The rectangles may be split into two, three or four smaller droplets of equal size. The rectangles may be split into three or four smaller droplets of equal size. The rectangles may be split into three smaller droplets of equal size. The rectangles may be split into four smaller droplets of equal size. The droplets may be square (in which case there are two longest axes and the square may be split into rectangles).

The droplets may be circular. Once elongated to ovals, the droplets can be split into smaller circles.

The droplets can be elongated prior to splitting providing the elongation does not split the droplet. Having the split droplets elongated prior to splitting makes splitting of the droplets more even as it increases tolerance against starting volume variations and compensates for reagent that is not actually actuated as it is part of the meniscus during the split.

The liquid volumes in the rectangles may be formed using an actuated meniscus, which acts to control the liquid volume prior to the split. The approach for example consists of describing (in the form of actuation patterns) a continuous transformation from an initial shape into one or more final shapes while keeping the actuated area constant throughout the process. The intermediate steps of the transformation are chosen such that they closely approximate (pixel-limited) the outline naturally assumed by a droplet deformed in such a way taking into account the tendency of the droplet to minimise its surface energy. This level of control allows keeping the pinch-off point consistent; making the process reproducible within and amongst devices and droplets. Disclosed is a method wherein multiple first droplets are formed, each using an actuated meniscus in order to normalise the volume of liquid between the first droplets to be split, and thereby the final droplets after splitting. The actuated meniscus is particularly beneficial when moving viscus or difficult to move reagents such as those containing beads.

Multiple droplets may be split simultaneously to form an array of droplets. The arrays may be generated by splitting such that the array has equal spacing s₁ along one axis and equal spacing s₂ along a second axis.

The split droplets may be further elongated and split into order to generate further, smaller droplets. Droplets may be split at least twice in order to make at least 4 smaller evenly sized droplets from each of the first droplets.

The final droplets may be for example less than 250 nL in volume. The final droplets may occupy fewer than 10 pixels of the electrokinetic device per droplet. The final droplets may occupy fewer than 4 pixels of the electrokinetic device per droplet. The invention is particularly beneficial when splitting small droplets, which otherwise would tend to split in a way that is not evenly distributed.

The first starting droplets may occupy at least 10×10 pixels of the electrokinetic device per droplet. Droplets may be any particular size. For example a droplet 64×18 pixels may be split into 2×32×18 pixels. A droplet of 9×2 pixels may be split into 2×3×3 pixels.

After splitting the droplets may be manipulated, for example by combining with other droplets. The droplets may contain reagents for assays, for example a nucleic acid template or a cell-free system having components for protein expression.

Described is a method for forming a plurality of droplets on an electrokinetic device, the method comprising taking one or more first droplets and splitting the one or more first droplets n times into smaller droplets, wherein n>=2 and the splitting occurs in at least two directions, x and y, on the electrokinetic device.

Described is a method for forming a plurality of droplets on an electrokinetic device, the method comprising taking two or more first droplets and splitting each of the first droplets n times into smaller droplets, wherein n>=2 and the splitting occurs in at least two directions, x and y, on the electrokinetic device to form a regular two-dimensional array with drops having equal spacing s₁ along one axis and equal spacing s₂ along a second axis.

Droplet splitting in this manner has many advantages over repeatedly dispensing droplets from a larger reservoir. The method is efficient in the use of space on the device. An array of droplets as a grid can be formed in a similar area to the size of the original droplet. The method is also efficient in the use of reagents, as all the material dispensed onto the device can be used to form droplets. The method is also efficient in the use of time, as a large number of droplets can be formed in the shortest time when compared to the single dispense operations. Splitting in this manner also reduces the variability between the sizes of different droplets. Where each volume is repeatedly halved, the variability in volume between the final droplets is less than where droplets are repeatedly dispensed from a reservoir. Large numbers of areas of differing liquid volumes can be rapidly produced on the device.

The droplet can be split at least twice in each direction to make at least 16 smaller droplets from each of the one or more first droplets.

The splitting can occur using a repeating pattern. The splitting can be recursive such that the array is formed with an even distribution of droplets on the surface of the electrokinetic device. The splitting can be iterative.

The splitting can reduce the volume of the droplet in defined proportions. Each droplet can be halved by each splitting. Each of the splits can half the volume of the droplet. The split can pull the droplet into three smaller droplets. The split can pull the droplet into four smaller droplets. Each splitting does not have to be the same size. Thus the droplets can be split into 3 along one axis, then halved on the other axis, thus making 6 droplets from the first droplet.

A large number of droplets can be split simultaneously. For example 96 first droplets can be split at the same time. Thus 96 droplets can be split in half to form 192 droplets. Each of the 192 can be further split into 384.

The two directions x and y are typically at 90° to each other in order to form the array within the smallest area.

The final droplets can be less than 1 μL in volume. The final droplets can be less than 500 nL in volume. The final droplets can be less than 250 nL in volume. The final droplets can be less than 100 nL in volume. The final droplets typically occupy only a few pixels on the array, for example less than 10×10 pixels. The final droplets may occupy 4×4 pixels on the array. The final droplets may occupy less than 4×4 pixels on the array.

The initial droplets are typically in the range of 0.5 to 1 μL in volume. The first droplets typically occupy at least 14×14 pixels of the electrokinetic device per droplet.

The droplets can be used in a variety of assays, for example in assays where dilution to single molecules or single cells per reaction volume is desirable. For example the method can be used to obtain single cells per droplet or single nucleic acid templates per droplet. The single nucleic templates can be amplified in order to produce isolated amplicons. The droplets can be used to express proteins, for example using a cell-free expression system, wherein the droplets contain nucleic acid templates and a cell-free system having components for protein expression.

Assays can be performed on the droplets, for example to determine the presence of or sequence of nucleic acids in a sample.

During operation on a high density electrode array, droplets and locations can be defined in a discreet fashion based on the number of pixels, e.g. droplet size of 10×10 pixels, droplet location of (100, 200) pixels. The first step to quickly generate a large ordered array of droplets is to dispense a small number of large droplets into an ordered array. These are the first droplets. In order to generate the large array quickly, the droplets are split multiple times along both the horizontal and vertical axes. The reason for this is it will avoid droplet collisions and the requirement of having to move droplets around after splitting them.

The manipulation of droplets is shown in FIG. 1. A rectangular droplet is optimally split by moving the opposing ends in opposite directions ‘up and down’ rather than by pulling the ends apart. In FIG. 1, two squares are produced, but the split can produce shapes that are still rectangular (when the length of the starting shape is more than twice the width).

FIG. 2 shows a longer rectangular shape which can be split into 4. The four sections are produced by ‘sliding’ sections of the liquid past each other. Four squares can be produced if the four sections are move up, down, up, down.

The droplet may be split into 3 sections if the two ends are moved in the same direction and the centre is moved in the opposite direction.

The droplets held on the device may be square, square droplets (or as square as possible) are dispensed onto the array from reservoirs along the edges of the device (as many as desired). The droplets are organized into rows and columns, equally spaced apart, though the spacing need not be identical along each axis.

The droplets being split can take any shape. A square droplet can be split along any central axis to make multiple droplets of substantially equal volume. The droplets can be split horizontally or vertically to make two rectangles, or along both axes to make 4 squares. The shape of the droplets are governed by the pixel activation on the array.

Where the droplets are square, the droplets may be elongated to rectangular shapes prior to splitting. The aspect ratio (length to width) may be greater than 2 to split. The aspect ratio may be greater than 4. A longer aspect ratio is preferred in order to maximise the radius of curvature.

Alternatively the droplets can be round in shape.

Where the droplets contain the same reagents, the droplets may be split, remerged and re-split in order to promote reagent mixing and reduce inhomogeneity between droplets.

The procedure can be carried out with multiple reagents sourcing the initial droplets, and is performed on a high density electrode grid (i.e. >100×100 electrodes). A digital microfluidics cell comprised of a TFT and an ITO/glass top plate may be used,

The droplets are aqueous droplets. The droplets may be within an infilling oil. The oil can be mineral oil, silicone oil such as dodecamethylpentasiloxane (DMPS), an alkyl-based solvent such as decane or dodecane, or a fluorinated oil. The droplets and/or oil may contain surfactants to adjust surface tension.

The splitting involves turning off one or more of the electrodes under the existing droplet whilst turning on pixel electrodes adjacent to one or both sides of the droplet. Thus one end or both ends of the droplet move in lateral directions until the join between them breaks. Thus the droplets are slid apart using the electrodes on the device. The sliding split generally makes even sized droplets. The lateral flow (i.e. flow in opposite directions on the device) across the longest axis increases the homogeneity of droplet sizing when compared to droplets that are pulled apart along the longest axis.

Typically, the electrodes (or the array elements) used for EWOD are covered with (i) a hydrophilic insulator/dielectric and a hydrophobic coating or (ii) a hydrophobic insulator/dielectric. Commonly used hydrophobic coatings comprise of fluoropolymers such as Teflon AF 1600 or CYTOP. The thickness of this material as a hydrophobic coating on the dielectric is typically <100 nm and can have defects in the form of pinholes or a porous structure; hence, it is particularly important that the insulator/dielectric is pinhole free to avoid electrical shorting. Teflon has also been used as an insulator/dielectric, but it has higher voltage requirements due to its low dielectric constant and the thickness required to make it pinhole free. Other hydrophobic insulator/dielectric materials can include polymer-based dielectrics such as those based on siloxane, epoxy (e.g. SU-8), or parylene (e.g., parylene N, parylene C, parylene D, or parylene HT). Due to minimal contact angle hysteresis and a higher contact angle with aqueous solutions, Teflon is still used as a hydrophobic topcoat on these insulator/dielectric polymers. However, there are difficulties in reliably producing <1 micron pinhole-free coatings of parylene or SU-8; thus, the thickness of these materials is typically kept at 2-5 microns at the cost of increased voltage requirements for electrowetting. It has also been reported that traditional EWoD devices with parylene C are easily broken and unstable for repeated droplet manipulation with cell culture medium. Multi-layer insulator devices deposited with metal-oxide and parylene C films have been used to produce a more robust insulator/dielectric and enable operations with lower applied voltages. Inorganic materials, such metal oxides and semiconductor oxides, commonly used in the CMOS industry as “gate dielectrics”, have been used as insulator/dielectric for EWoD devices. They offer the advantage of utilizing standard cleanroom processes for thin film depositions (<100 nm). These materials are inherently hydrophilic, requiring an additional hydrophobic coating, and can be prone to pinhole formation as a result of thin film layer deposition process.

Together with the need for lower voltage operations of EWoD, recent developmental work has focused on (1) using materials with improved dielectric properties (e.g., using high-dielectric constant insulators/dielectrics), (2) optimizing the fabrication process to make the insulator/dielectric pinhole free to avoid dielectric breakdown.

The electrokinetic device may include a first substrate having a matrix of electrodes, wherein each of the matrix electrodes is coupled to a thin film transistor, and wherein the matrix electrodes are overcoated with a functional coating comprising: a dielectric layer in contact with the matrix electrodes, a conformal layer in contact with the dielectric layer, and a hydrophobic layer in contact with the conformal layer; a second substrate comprising a top electrode; a spacer disposed between the first substrate and the second substrate and defining an electrokinetic workspace; and a voltage source operatively coupled to the matrix electrodes. The method further comprises disposing an aqueous droplet on a first matrix electrode; and providing a differential electrical potential between the first matrix electrode and a second matrix electrode with the voltage source, thereby moving the aqueous droplet in multiple directions in order to repeatedly split the droplet.

The inventors discovered that contact angle hysteresis arising from high conductivity solutions or solutions deviating from neutral pH can be mitigated by depositing a conformal layer. The method and device can be used when the ionic strength is over 0.1 M and over 1.0 M.

The inventors have discovered that contact angle hysteresis on EWoD-based devices arising from high conductivity solutions or solutions deviating from neutral pH can be mitigated by depositing a thin protective parylene coating in between the insulating dielectric and the hydrophobic coating.

The ability to robustly actuate high ionic strength solutions for extended periods of time offers great utility to those wishing to conduct certain biochemical processes and experiments. High ionic strength solutions are commonly used as wash buffers to disrupt the interaction of nucleic acids and proteins, for example in the commonly performed chromatin immunoprecipitation (ChIP) assay. High ionic strength solutions can also be used for osmotic cell lysis. Additionally, the culture of marine algae is typically performed in media isotonic with seawater, with an ionic strength of 600-700 mM. A further application of high ionic strength solutions is for the elution of proteins from affinity matrices following purification. High ionic strength buffers are also used in enzymatic nucleic acid synthesis. Multiple high ionic strength solutions (1000 mM monovalent or greater) can be used in enzymatic DNA synthesis processes during both washing and deprotection steps.

The dielectric layer may comprise silicon dioxide, silicon oxynitride, silicon nitride, hafnium oxide, yttrium oxide, lanthanum oxide, titanium dioxide, aluminium oxide, tantalum oxide, hafnium silicate, zirconium oxide, zirconium silicate, barium titanate, lead zirconate titanate, strontium titanate, or barium strontium titanate. The dielectric layer may be between 10 nm and 100 μm thick. Combinations of more than one material may be used, and the dielectric layer may comprise more than one sublayer that may be of different materials.

Exemplary layers can be seen in application WO2020226985. Dielectric layers of the invention can be deposited on a substrate, for example a substrate including a plurality of electrodes disposed between the substrate and the layered dielectric. In some embodiments, the electrodes are disposed in an array and each electrode is associated with a thin film transistor (TFT). In some embodiments, a hydrophobic layer is deposited on the third layer, i.e., on top of the dielectric stack. In some embodiments, the hydrophobic layer is a fluoropolymer, which can be between 10 and 50 nm thick, and deposited with spin-coating or another coating method. Also described herein is a method for creating a layered dielectric of the type described above. The method includes providing a substrate, depositing a first layer using atomic layer deposition (ALD), depositing a second layer using sputtering, and depositing the third layer using ALD. (The first layer is deposited on the substrate, the second layer is deposited on the first layer, and the third layer is deposited on the second layer). The first ALD layer typically includes aluminium oxide or hafnium oxide and has a thickness between 9 nm and 80 nm. The second sputtered layer can include tantalum oxide or hafnium oxide and has a thickness between 40 nm and 250 nm. The third ALD layer typically includes tantalum oxide or hafnium oxide and has a thickness between 5 nm and 60 nm. In some embodiments, the atomic layer deposition comprises plasma-assisted atomic layer deposition. In some embodiments, the sputtering comprises radio-frequency magnetron sputtering. In some embodiments, the method further includes spin coating a hydrophobic material on the third layer.

Optionally the dielectric ‘layer’ may include multiple layers. The first layer may include aluminium oxide or hafnium oxide, and have a thickness between 9 nm and 80 nm. The second layer may include tantalum oxide or hafnium oxide, and have a thickness between 40 nm and 250 nm. The third layer may include tantalum oxide or hafnium oxide, and have a thickness between 5 nm and 60 nm. The second and third layers may comprise different materials, for example, the second layer can comprise primarily hafnium oxide while the third layer comprises primarily tantalum oxide. Alternatively, the second layer can comprise primarily tantalum oxide while the third layer comprises primarily hafnium oxide. In some embodiments, the first layer may be aluminium oxide. In preferred embodiments, the first layer is from 20 to 40 nm thick, while the second layer is 100 to 150 nm thick, and the third layer is 10 to 35 nm thick. The thickness of the various layers can be measured with a variety of techniques, including, but not limited to, scanning electron microscopy, ion beam backscattering, X-ray scattering, transmission electron microscopy, and ellipsometry.

The conformal layer may comprise a parylene, a siloxane, or an epoxy. It may be a thin protective parylene coating in between the insulating dielectric and the hydrophobic coating. Typically, parylene is used as a dielectric layer on simple devices. In this invention, the rationale for deposition of parylene is not to improve insulation/dielectric properties such as reduction in pinholes, but rather to act as a conformal layer between the dielectric and hydrophobic layers. The inventors find that parylene, as opposed to other similar insulating coatings of the same thickness such as PDMS (polydimethylsiloxane), prevent contact angle hysteresis caused by high conductivity solutions or solutions deviating from neutral pH for extended hours. The conformal layer may be between 10 nm and 100 μm thick.

Disclosed is a method for repeatedly splitting an aqueous droplet, comprising: providing an electrokinetic device, including:
a first substrate having a matrix of electrodes, wherein each of the matrix electrodes is coupled to a thin film transistor, and wherein the matrix electrodes are overcoated with a functional coating comprising:
   one or more dielectric layer(s) comprising silicon nitride, hafnium oxide or aluminium oxide in contact with the matrix electrodes,
   a conformal layer comprising parylene in contact with the dielectric layer, and
   a hydrophobic layer in contact with the conformal layer;
a second substrate comprising a top electrode;
   a spacer disposed between the first substrate and the second substrate and defining an electrokinetic workspace; and
a voltage source operatively coupled to the matrix electrodes;
   providing a first aqueous droplet on a first matrix electrode; and
providing a differential electrical potential between the first matrix electrode and two second matrix electrodes with the voltage source, thereby splitting the aqueous droplet, and providing a further differential electrical potential using further matrix electrodes in order to further split the droplets.

The hydrophobic layer may comprise a fluoropolymer coating, fluorinated silane coating, manganese oxide polystyrene nanocomposite, zinc oxide polystyrene nanocomposite, precipitated calcium carbonate, carbon nanotube structure, silica nanocoating, or slippery liquid-infused porous coating.

The elements may comprise one or more of a plurality of array elements, each element containing an element circuit; discrete electrodes; a thin film semiconductor in which the electrical properties can be modulated by incident light; and a thin film photoconductor whose properties can be modulated by incident light.

The functional coating may include a dielectric layer comprising silicon nitride, a conformal layer comprising parylene, and a hydrophobic layer comprising an amorphous fluoropolymer. This has been found to be a particularly advantageous combination.

The electrokinetic device may include a controller to regulate a voltage provided to the individual matrix electrodes. The electrokinetic device may include a plurality of scan lines and a plurality of gate lines, wherein each of the thin film transistors is coupled to a scan line and a gate line, and the plurality of gate lines are operatively connected to the controller. This allows all the individual elements to be individually controlled.

The second substrate may also comprise a second hydrophobic layer disposed on the second electrode. The first and second substrates may be disposed so that the hydrophobic layer and the second hydrophobic layer face each other, thereby defining the electrokinetic workspace between the hydrophobic layers.

The method is particularly suitable for splitting aqueous droplets with a volume of 1 μL or smaller.

The present invention can be used to contact adjacent aqueous droplets by disposing a second aqueous droplet on a third matrix electrode and providing a differential electrical potential between the third matrix electrode and the second matrix electrode with the voltage source.

The invention further provides an assay, nucleic acid synthesis, nucleic acid assembly, nucleic acid amplification, nucleic acid manipulation, next-generation sequencing library preparation, protein synthesis, or cellular manipulation comprising repeating the method steps described above.

The insulator/dielectric may be made of SiO₂, silicon oxynitride, Si₃N₄, hafnium oxide, yttrium oxide, lanthanum oxide, titanium dioxide, aluminium oxide, tantalum oxide, hafnium silicate, zirconium oxide, zirconium silicate, barium titanate, lead zirconate titanate, strontium titanate, barium strontium titanate, parylene siloxane, epoxy or a mixture thereof. The insulator/dielectric layer has a thickness of 10-10,000 nm.

The hydrophobic coat may comprise a fluoropolymer such as, for example, Teflon, CYTOP or PTFE. The hydrophobic coating layer may be made of an amorphous fluoropolymer or siloxane or organic silane. The hydrophobic layer has a thickness of 1-1,000 nm.

A second electrode is positioned opposite the array of individually controllable elements and the second electrode and the individually controllable elements are separated by a spacer which defines an electrokinetic workspace.

In order to promote adhesion between the different layer gaseous precursors are often used. This can be used when the layers are deposited using a spin coating or a dip coating.

The EWoD-based devices shown and described below are active matrix thin film transistor devices containing a thin film dielectric coating with a Teflon hydrophobic top coat. These devices are based on devices described in the E Ink Corp patent filing on “Digital microfluidic devices including dual substrate with thin-film transistors and capacitive sensing”, US patent application no 2019/0111433, incorporated herein by reference.

Described herein are electrokinetic devices, including:
a first substrate having a matrix of electrodes, wherein each of the matrix electrodes is coupled to a thin film transistor, and wherein the matrix electrodes are overcoated with a functional coating comprising:
a dielectric layer in contact with the matrix electrodes,
a conformal layer in contact with the dielectric layer, and
a hydrophobic layer in contact with the conformal layer;
   a second substrate comprising a top electrode;
   a spacer disposed between the first substrate and the second substrate and defining an electrokinetic workspace; and
   a voltage source operatively coupled to the matrix electrodes;

The electrokinetic devices as described may be used with other elements, such as for example devices for heating and cooling the device or reagent cartridges for the introduction of reagents as needed.

The devices can be used for any biochemical assay process involving high solute (ionic) strength solutions where the high concentration of ions would otherwise degrade and prevent use of prior art devices. The devices are particularly advantageous for processes involving the synthesis of biomolecules such as for example nucleic acid synthesis, for example using template independent strand extensions, or cell-free protein expression using a population of different nucleic acid templates.

### FIGURES

FIG. 1 shows a schematic representation of a droplet being split laterally into two equal sized droplets. The splitting pattern splits rectangles along their shortest axis by moving the ends laterally (up and down rather than apart). White colour represents the pixel electrodes which are turned ON and black represents the OFF electrodes.

FIG. 2 shows a schematic representation of a droplet being split laterally into four equal sized droplets. The splitting pattern splits rectangles along their shortest axis by moving the ends laterally (up and down rather than apart). White colour represents the pixel electrodes which are turned ON and black represents the OFF electrodes.

FIG. 3 shows electrode actuation for lateral split method (white shows electrodes ON, black is OFF) of 14×14 droplet into two 20×5 droplets. The square droplet (a) is resized to the rectangular shape (b) which is followed by the lateral (sliding) motion of two halves toward the perpendicular direction of the resized droplet (c-d). It is observed as a controlled split of the initial droplet into two even halves. The reliability of the method relies in maximized radiuses of curvature for both droplets (R1 and R2). It minimizes the Laplace pressure from both opposite corners which is especially essential if two droplets are not identical. It reduces the flow of the aqueous phase from the smaller droplet (smaller radius of curvature and higher Laplace pressure) toward the larger droplet (larger radius of curvature and smaller Laplace pressure). This can occur for example if the device experiences lack of applied voltage to the pixels, for example due to reloading images etc. White colour represents the pixel electrodes which are turned ON and black represents the OFF electrodes.

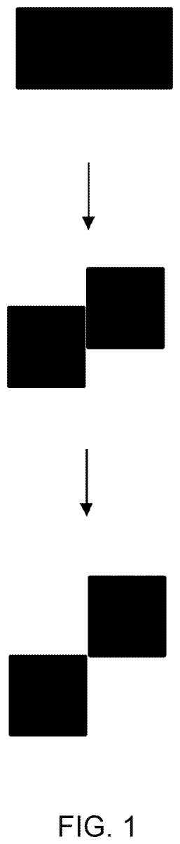

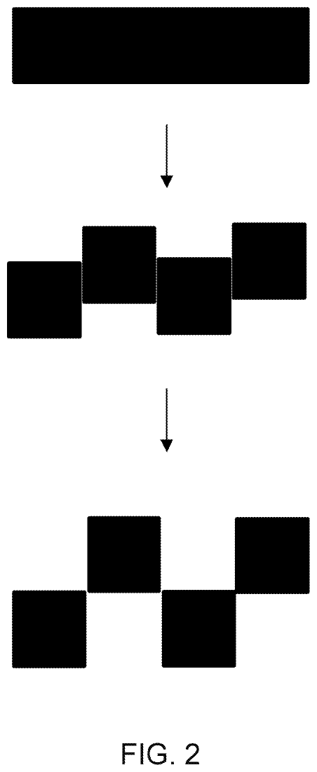

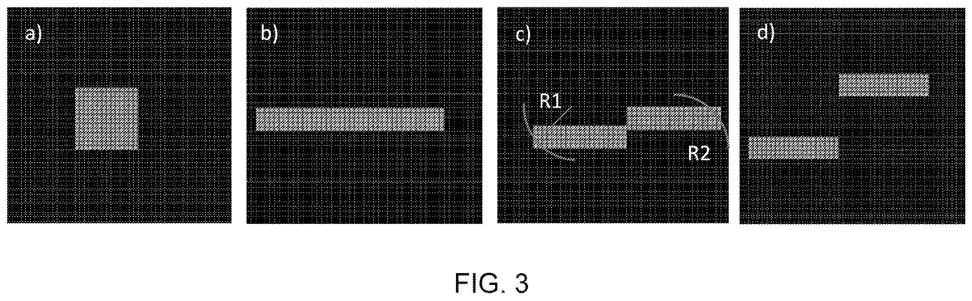

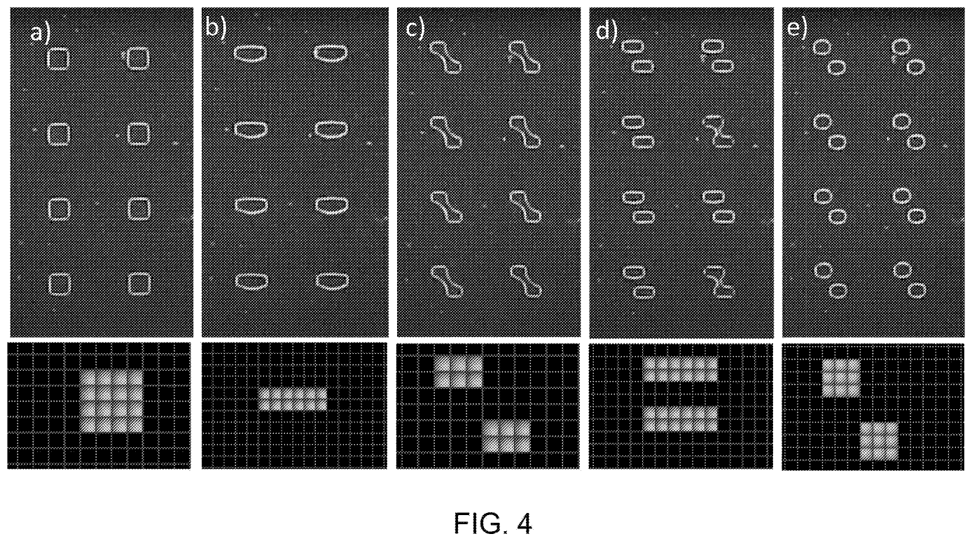

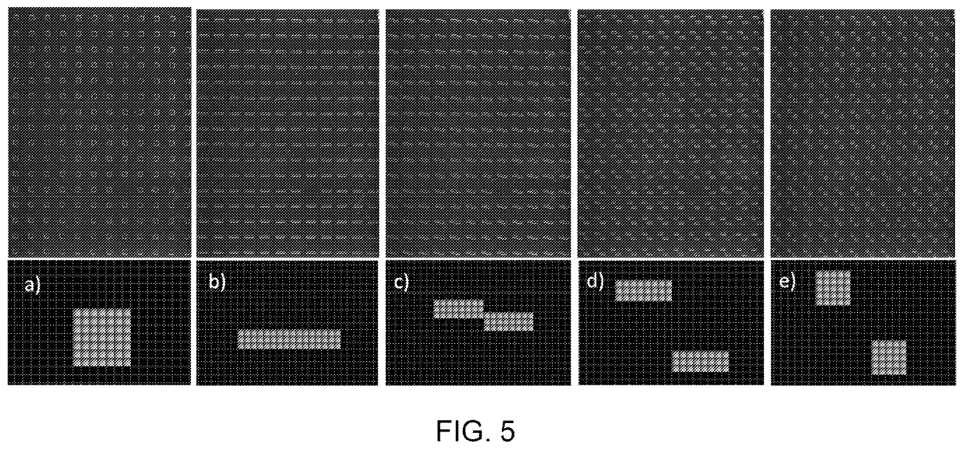

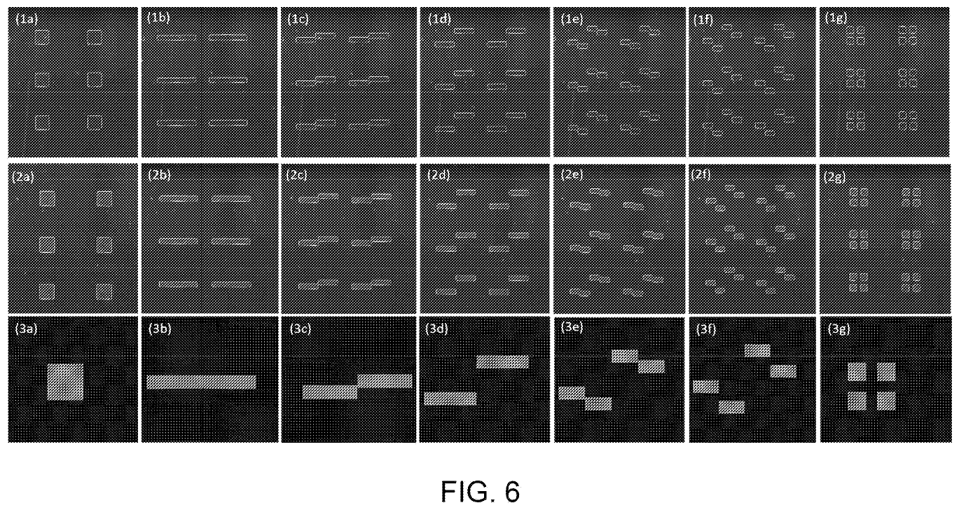

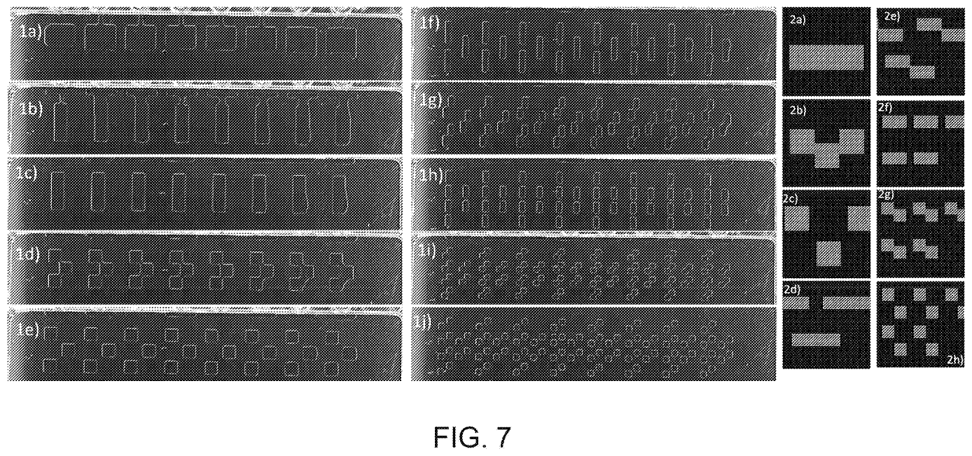

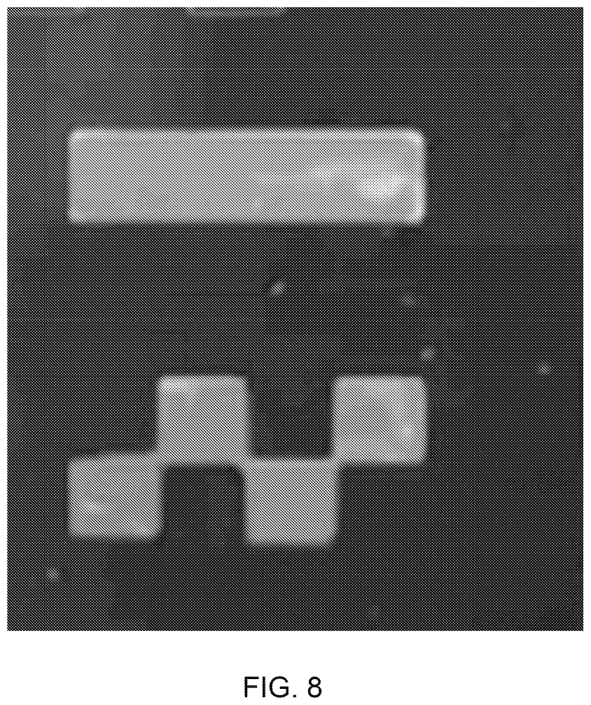

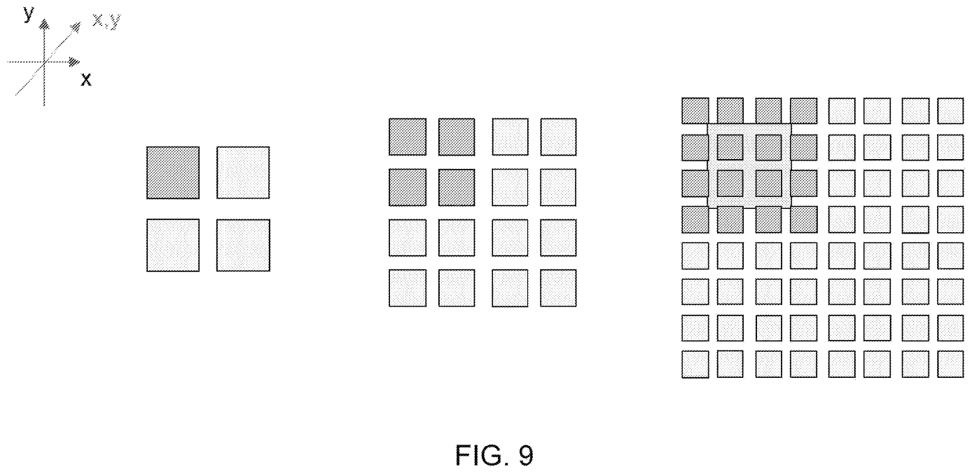

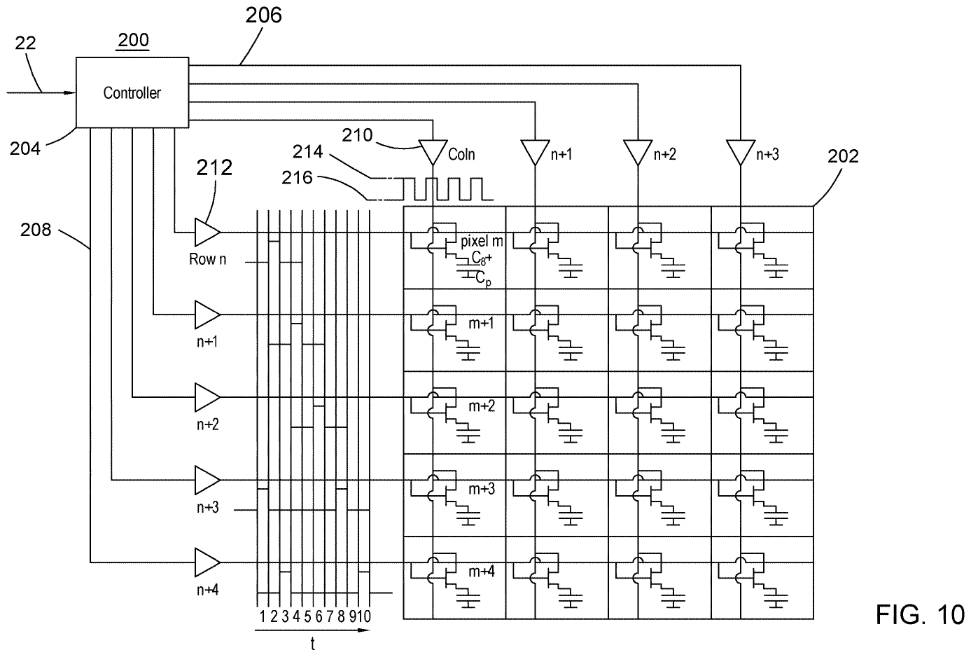

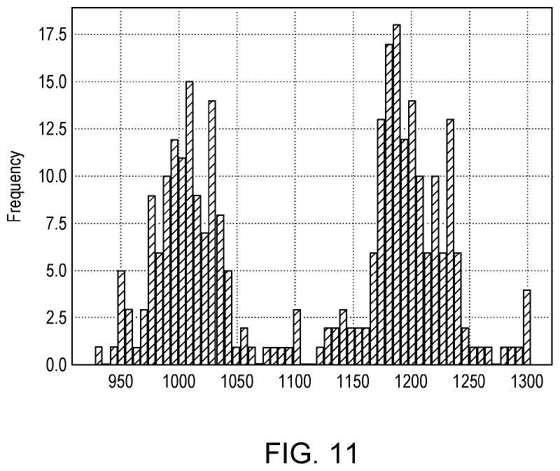

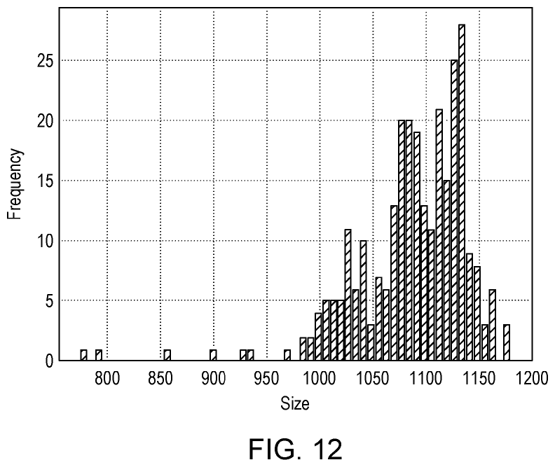

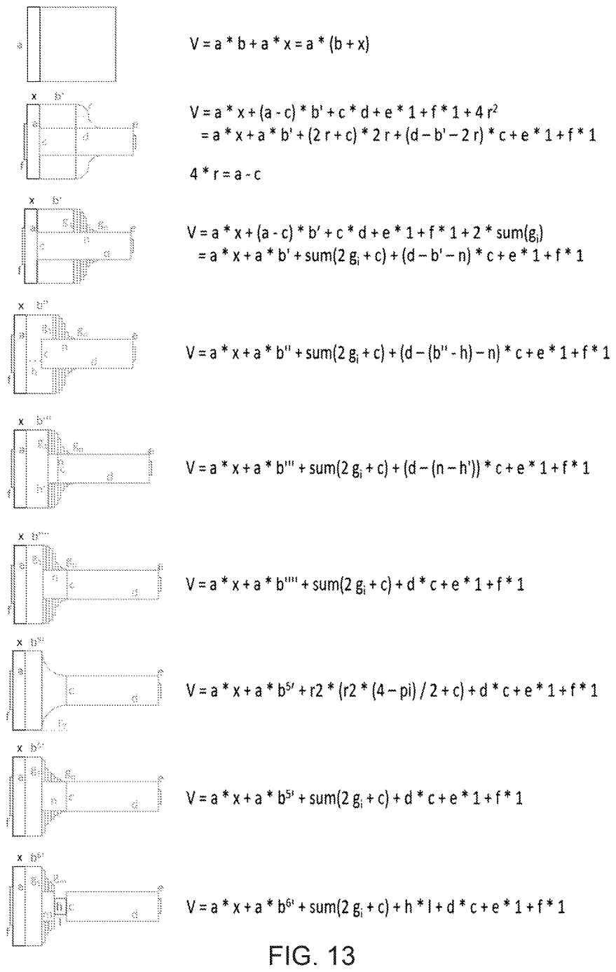

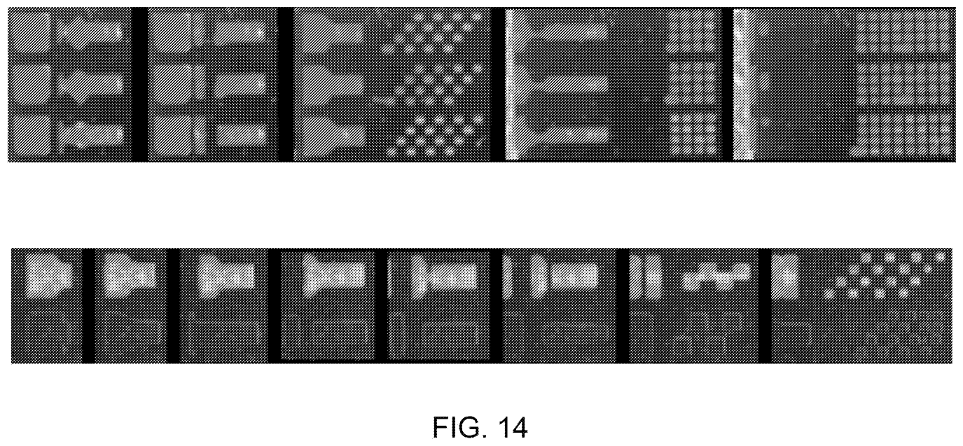

FIG. 4 shows splitting of 4×4 pixels droplets into two 3×3 pixels droplets using sliding splitting method:
a: 4×4 pixel droplets before splitting
b: droplets are resized to 6×3 pixels to initiate splitting
c: sliding splitting into two 3×2 pixels droplets
d: an additional area is actuated to finalize splitting
e: resized and rearranged 3×3 pixels droplets

White colour represents the pixel electrodes which are turned ON and black represents the OFF electrodes.

FIG. 5 shows a split an array of 192 7×7 pixels droplets to 384 5×5 droplets using sliding split:
a: 7×7 pixels droplets before splitting
b: droplets are resized to 16×3 pixels to initiate splitting
c-d: sliding splitting into two 8×3 pixels droplets
e: resized and rearranged 5×5 pixels droplets.
and their associated driving patterns.

White colour represents the pixel electrodes which are turned ON and black represents the OFF electrodes.

FIG. 6 shows a split from 14×14 to four 7×7 pixels:
1a, 2a: 14×14 pixels droplets before splitting
1b, 2b: droplets are resized to 40×5 pixels to initiate splitting
1c-d, 2c-d: sliding splitting into two 20×5 pixels droplets
1e-f, 2e-f: another sliding splitting into 10×5 pixels droplets
1g, 2g: resized and rearranged 7×7 pixels droplets
and their associated driving patterns (3a-g).

Top and middle panel show images of 14×14 aqueous reagent undergoing splitting at room temperature and 37° C. and the bottom panel shows actuation pattern. White colour represents the pixel electrodes which are turned ON and black represents the OFF electrodes.

FIG. 7 shows high throughput 7×7 pixels droplets dispense using slide split method:
1a-c: formation of 14×42 pixels daughter reservoirs to dispense twelve 7×7 pixels droplets
1d-e: split of daughter reservoirs into three 14×14 droplets
1f-h: following split into 7×14 droplets
1i-j: last split into 7×7 droplets
and their associated driving patterns (2a-h).

White colour represents the pixel electrodes which are turned ON and black represents the OFF electrodes.

FIG. 8 shows static images from a video of aqueous droplet being split on an EWoD device. The splitting pattern splits a rectangle along its shortest axis by moving the ends and central parts laterally (up and down rather than apart). The rectangle can be split directly into four droplets (squares) using lateral movements.

FIG. 9 shows the spacing requirement of a split array. The repeated splitting allows generation of a large number of droplets in a space similar to the starting space of the initial droplet.

FIG. 10 depicts an array of individually controllable elements forming an electrode array 202. FIG. 10 is a diagrammatic view of an exemplary driving system 200 for controlling droplet operation by an AM-EWOD propulsion electrode array 202. The AM-EWOD driving system 200 may be in the form of an integrated circuit adhered to a support plate. The elements of the EWoD device are arranged in the form of a matrix having a plurality of data lines and a plurality of gate lines. Each element of the matrix contains a TFT for controlling the electrode potential of a corresponding electrode, and each TFT is connected to one of the gate lines and one of the data lines. The electrode of the element is indicated as a capacitor Cp. The storage capacitor Cs is arranged in parallel with Cp and is not separately shown in FIG. 10. The controller shown comprises a microcontroller 204 including control logic and switching logic. It receives input data relating to droplet operations to be performed from the input data lines 22. The microcontroller has an output for each data line of the EWoD matrix, providing a data signal. A data signal line 206 connects each output to a data line of the matrix. The microcontroller also has an output for each gate line of the matrix, providing a gate line selection signal. A gate signal line 208 connects each output to a gate line of the matrix. A data line driver 210 and a gate line driver 212 is arranged in each data and gate signal line, respectively. The figure shows the signals lines only for those data lines and gate lines shown in the figure. The gate line drivers may be integrated in a single integrated circuit. Similarly, the data line drivers may be integrated in a single integrated circuit. The integrated circuit may include the complete gate driver assembly together with the microcontroller. The integrated circuit may be integrated on a support plate of the AM-EWOD device. The integrated circuit may include the entire AM-EWOD device driving system. The data line drivers provide the signal levels corresponding to a droplet operation. The gate line drivers provide the signals for selecting the gate line of which the electrodes are to be actuated. As illustrated in FIG. 10, traditional AM-EWOD cells use line-at-a-time addressing, in which one gate line n is high while all the others are low. The signals on all of the data lines are then transferred to all of the pixels in row n. At the end of the line time gate line n signal goes low and the next gate line n+1 goes high, so that data for the next line is transferred to the TFT pixels in row n+1. This continues with all of the gate lines being scanned sequentially so the whole matrix is driven. This is the same method that is used in almost all AM-LCDs, such as mobile phone screens, laptop screens and LC-TVs, whereby TFTs control the voltage maintained across the liquid crystal layer, and in AM-EPDs (electrophoretic displays).

FIG. 11 shows a histogram of droplet volume after splitting (measured as fluorescence intensity). The bimodal distribution arises from overactuation of the aqueous phase and the aspect ratio of the elongated droplet. The 8×8 droplet is resized to 12×6 and then to split droplets of 6×6.

FIG. 12 shows a histogram of droplet volume after splitting (measured as fluorescence intensity) using optimised aspect ratio of 16×4. Using an elongated volume to split means a bimodal distribution is not seen and the droplets have a low coefficient of variation (CV).

FIG. 13 shows a method for accurately forming rectangular volumes without overloading. An actuated meniscus is used to control the volume of the rectangles prior to splitting. The script generates a smooth transition from an initial step with the daughter reservoir partially protruding from the mother reservoir through to full detachment while keeping the full actuated area constant at all times by resizing the mother reservoir iteratively. The figure shows snapshots during the process of forming rectangular volumes. The middle of the figure describes an ideal case where the meniscus between mother and daughter reservoir is continuous and the bottom sketch shows the stepwise approximation used in the algorithm. Once the daughter reservoir is formed, it is stepwise shifted forward one pixel column at a time. The mother reservoir is resized to match, with a single row at its back (height f) resized to adjust the total volume. As the daughter reservoir moves forward, different conditions are encountered depending on whether the near end of the daughter reservoir is located inside the mother reservoir proper or within the meniscus. This process is complete once the daughter reservoir has travelled far enough forward to sit at the end of the meniscus. In the next steps, the meniscus switches shape from undulating to fully concave. Then, a bridge (here of width I=4 px) is formed and its width is gradually reduced until the daughter reservoir is detached. The volumes taken up by each fluid area are shown as calculations.

FIG. 14 shows results with and without meniscus actuation. Without meniscus actuation (top), several of the droplets dispensed are overfilled. Using meniscus actuation to control the volume of the initial rectangle, the split volumes are accurate and not overfilled (bottom).

### APPLICATIONS OF THE INVENTION

The invention can be used in a myriad of different applications. In particular the invention can be used to move cells, nucleic acids, nucleic acid templates, proteins, initiation oligonucleotide sequences for nucleic acid synthesis, beads, magnetic beads, cells immobilised on magnetic beads, or biopolymers immobilised on magnetic beads.

In these applications the steps of disposing an aqueous droplet having an ionic strength on a first matrix electrode and providing a differential electrical potential may be repeated many times. They may be repeated over 1000 times or over 10,000 times, sometimes over a 24 hour period.

### Nucleic Acid Syntheses Applications

The present method can be used in the synthesis of nucleic acids, such as phosphoramidite-based nucleic acid synthesis, templated or non-templated enzymatic nucleic acid synthesis, or more specifically, terminal deoxynucleotidyl transferase (TdT) mediated addition of 3′-O-reversibly terminated nucleoside 5′-triphosphates to the 3′-end of 5′-immobilized nucleic acids. During enzymatic nucleic acid synthesis, the following steps are taken on the instrument:
1. Addition solution containing TdT, optionally pyrophosphatase (PPiase), 3′-O-reversibly terminated dNTPs, and required buffer (including salts and necessary reaction components such as metal divalents) is brought to a reaction zone containing an immobilized nucleic acid, where the nucleic acid is immobilized on a surface such as through magnetic beads via a covalent linkage to the 5′ terminus of the nucleic acid. The initial immobilized nucleic acid may be known as an initiator oligonucleotide and comprises N nucleotides, for example 3-100 nucleotides, preferably 10-80 nucleotides, and more preferably 20-65 nucleotides. Initiator oligonucleotides may contain a cleavage site, such as a restriction site or a non-canonical DNA base such as U or 8-oxoG. Addition solution may optionally contain a phosphate sensor, such as E. coli phosphate-binding protein conjugated to MDCC fluorophore, to assess the quality of nucleic acid synthesis as a fluorescent output. dNTPs can be combined in ratios to make DNA libraries, such as NNK syntheses.
2. Wash solution, either in bulk or in discrete droplets, is applied to reaction zones to wash away the addition solution. Wash solution typically has a high solute concentration (>1 M NaCl).
3. Deprotection solution, either in bulk or in discrete droplets, is applied to reaction zones to deprotect the 3′-O-reversible terminator added to the immobilized nucleic acids in the immobilized nucleic acid zone in step I. Deprotection solution typically has a high solute concentration.
4. Wash solution, either in bulk or in discrete droplets, is applied to reaction zones to wash away the deprotection solution.
5. Steps I-IV are repeated until desired sequences are synthesized, for example steps I-IV are repeated 10, 50, 100, 200 or 1000 times.

The present method can be used in the preparation of oligonucleotide sequences, either via synthesis or assembly. The device allows synthesis and movement of defined sequences.

Using the present method the initiation sequences can be modified at a specific location above an electrode and the extended oligonucleotides prepared. The initiation sequences at different locations can be exposed to different nucleotides, thereby synthesising different sequences in different regions of the electrokinetic device.

After synthesis of a defined population of different sequences in different regions of the electrokinetic device, the sequences can be further assembled in longer contiguous sequences by joining two or more synthesised strands together.

Described herein is a method for preparing a contiguous oligonucleotide sequence of at least 2n bases in length comprising taking the electrokinetic device as described herein having a plurality of immobilised initiation oligonucleotide sequences, one or more of which contains a cleavage site, using the initiation oligonucleotide sequences to synthesise a plurality of immobilised oligonucleotide sequences of at least n bases in length, using cycles of extension of reversibly blocked nucleotide monomers, selectively cleaving at least two of the immobilised oligonucleotide sequences of least n bases in length into a reaction solution whilst leaving one or more of the immobilised oligonucleotide sequences attached, hybridizing at least two of the cleaved oligonucleotides to each other, to form a splint, and hybridizing one end of the splint to one of the immobilized oligonucleotide sequences and joining at least one of the cleaved oligonucleotides to the immobilised oligonucleotide sequences, thereby preparing a contiguous oligonucleotide sequence of at least 2n bases in length.

The steps of synthesis and assembly may involve high solute concentrations where the ionic strength would degrade the devices without the protecting conformal layer.

The method of moving aqueous droplets may also be used to help facilitate cell-free expression of peptides or proteins. In particular, droplets containing a nucleic acid template and a cell-free system having components for protein expression in an oil-filled environment can be moved using a method of the invention in the described electrokinetic device.

The present invention can be used to automate the movements of droplets in a cartridge. For example, droplets intended for analysis can be moved according to the present invention. The present invention could be incorporated into a cartridge used for local clinician diagnostics. For example it could be used in conjunction with nucleic acid amplification testing (NAAT) to determine nucleic acid targets in, for example, genetic testing for indications such as cancer biomarkers, pathogen testing for example detecting bacteria in a blood sample or virus detection, such as a coronavirus, e.g. SARS-COV-2 for the diagnosis of COVID-19.

The device may be thermocycled to enable nucleic acid amplification, or the device may be held at a desired temperature for isothermal amplification. Having different sequences synthesised in different regions of the device allows multiplex amplification using different primers in different regions of the device.

Furthermore the invention can be used in conjunction with next generation sequencing in which DNA is synthesised by the addition of nucleotides and large numbers of samples are sequenced in parallel. The present invention can be used to accurately locate the individual samples used in next generation sequencing.

The invention can be used to automate library preparation for next generation sequencing. For example the steps of ligation of sequencing adaptors can be carried out on the device. Amplification of a selective subset of sequences from a sample can then have adaptors attached to enable sequencing of the amplified population.

### Protein Expression Applications

The method of moving aqueous droplets may also be used to help facilitate cell-free expression of peptides or proteins. In particular, droplets containing a nucleic acid template and a cell-free system having components for protein expression in an oil-filled environment can be moved using a method of the invention in the described electrokinetic device.

Disclosed herein is a method for the real-time monitoring of in-vitro protein synthesis comprising
1. In-vitro transcription and translation of a protein of interest fused to a peptide tag; and
2. monitoring the presence of the peptide tag using a further polypeptide which in the presence of the peptide tag produces a detectable signal.

Disclosed herein is a method for the monitoring of cell-free protein synthesis in a droplet on a digital microfluidic device comprising
a. cell-free transcription and translation of a protein of interest fused to a peptide tag; and
b. monitoring the presence of the peptide tag using a further polypeptide which in the presence of the peptide tag produces a detectable signal.

The use of the terms “in-vitro” and “cell-free” may be used interchangeably herein.

The detectable signal may be for example fluorescence or luminescence. The detectable signal may also be caused by the binding of a ligand to the complemented oligopeptide, peptide, or polypeptide tag fused to the protein of interest.

The detectable signal may also be caused by the binding of the polypeptide to the protein of interest fused to a His-tag.

Any in-vitro transcription and translation may be used, for example extract-based systems derived from rabbit reticulocyte lysate, human lysate, Chinese Hamster Ovary lysate, a wheat germ, HEK293 lysate, E. coli lysate, yeast lysate.

Alternatively the in-vitro transcription and translation may be assembled from purified components, for example a system of purified recombinant elements (PURE).

The in-vitro transcription and translation may be coupled or uncoupled.

The peptide tag may be one component of a fluorescent protein and the further polypeptide a complementary portion of the fluorescent protein. The fluorescent protein could include sfGFP, GFP, ccGFP, eGFP, deGFP, frGFP, eYFP, eBFP, eCFP, Citrine, Venus, Cerulean, Dronpa, DsRED, mKate, mCherry, mRFP, FAST, SmURFP, miRFP670nano. For example the peptide tag may be GFP₁₁ and the further polypeptide GFP₁-10. The peptide tag may be one component of sfCherry. The peptide tag may be sfCherry₁₁ and the further polypeptide sfCherry₁₋₁₀. The peptide tag may be CFAST₁₁ or CFAST₁₀ and the further polypeptide NFAST in the presence of a hydroxybenzylidene rhodanine analog.

The peptide tag may also be one component of a protein that forms a detectable substrate, such as a luminescent or colorigenic substrate. The protein could include beta-galactosidase, beta-lactamase, or luciferase.

The protein may be fused to multiple tags. For example the protein may be fused to multiple GFP₁₁ peptide tags and the synthesis occurs in the presence of multiple GFP₁₋₁₀ polypeptides. For example the protein may be fused to multiple sfCherry₁₁ peptide tags and the synthesis occurs in the presence of multiple sfCherry₁₋₁₀ polypeptides. The protein of interest may be fused to one or more sfCherry₁₁ peptide tags and one or more GFP₁₁ peptide tags and the synthesis occurs in the presence of one or more GFP₁₋₁₀ polypeptides and one or more sfCherry₁₋₁₀ polypeptides.

Any protein of interest may be synthesised. The protein may be an enzyme, for example a terminal deoxynucleotidyl transferase (TdT) enzyme or a truncated version thereof or the homologous amino acid sequence of a terminal deoxynucleotidyl transferase (TdT) enzyme in other species or the homologous amino acid sequence of Polu, Polβ, PolA, and Pole of any species or the homologous amino acid sequence of X family polymerases of any species.

Protein expression typically requires an ample supply of oxygen. The most convenient and high yielding way to power CFPS is via oxidative phosphorylation where O₂ serves as the final electron acceptor; however, there are other ways that involve replenishing with energy molecules not involved in oxidative phosphorylation. In a confined microfluidic or digital microfluidic system of droplets, insufficient oxygen is available to enable efficient protein synthesis.

Described herein are improved methods allowing for the cell-free expression of peptides or proteins in a digital microfluidic device. Included is a method for the cell-free expression of peptides or proteins in a microfluidic device wherein the method comprises one or more droplets containing a nucleic acid template (i.e., DNA or RNA) and a cell-free system having components for protein expression in an oil-filled environment, and moving said droplets using electrowetting. The components for the cell-free protein synthesis droplet can be pre-mixed prior to introduction to or mixed on the digital microfluidic device.

The droplet can be repeatedly moved for at least a period of 30 minutes whilst the protein is expressed. The droplet can be repeatedly moved for at least a period of two hours whilst the protein is expressed. The droplet can be repeatedly moved for at least a period of twelve hours whilst the protein is expressed. The act of moving the droplet allows oxygen to be supplied to the droplet and dispersed throughout the droplet. The act of moving improves the level of protein expression over a droplet which remains static.

The droplet can be moved using any means of electrowetting. The droplet can be moved using electrowetting-on-dielectric (EWoD). The electrical signal on the EWoD or optical EWoD device can be delivered through segmented electrodes, active-matrix thin-film transistors, or digital micromirrors.

The filler fluid in the device can be any water immiscible liquid. The filler fluid can be mineral oil, silicone oil such as dodecamethylpentasiloxane (DMPS), an alkyl-based solvent such as decane or dodecane, or a fluorinated oil. The filler fluid can be oxygenated prior to or during the expression process.

A source of supplemental oxygen can be supplied to the droplets. For example droplets or gas bubbles containing gaseous or dissolved oxygen can be merged with the droplets during the protein expression. Additionally, a source of supplemental oxygen can be found by oxygenating the oil that is used as the filler medium. It is well-known in the art that oils such as hexadecane, HFE-7500, and others can be oxygenated to support the oxygen requirements of cell growth, especially E. coli cell growth (RSC Adv., 2017, 7, 40990-40995). Oxygenation can be achieved by aerating the oil with pure oxygen or atmospheric air.

The droplets can be formed before entering the microfluidic device and flowed into the device. Alternatively the droplets can be merged on the device. Included is a method comprising merging a first droplet containing a nucleic acid template such as a plasmid with a second droplet containing a cell-free extract having the components for protein expression to form a combined droplet capable of cell-free protein synthesis.

The droplets can be split on the device either before or after expression. Included herein is a method further comprising splitting the aqueous droplet into multiple droplets. If desired the split droplets can be screened with further additives. Included is a method wherein one or more of the split droplets are merged with additive droplets for screening.

The cell-free expression of peptides or proteins can use a cell lysate having the reagents to enable protein expression. Common components of a cell-free reaction include an energy source, a supply of amino acids, cofactors such as magnesium, and the relevant enzymes. A cell extract is obtained by lysing the cell of interest and removing the cell walls, DNA genome, and other debris by centrifugation. The remains are the cell machinery including ribosomes, aminoacyl-tRNA synthetases, translation initiation and elongation factors, nucleases, etc. Once a suitable nucleic acid template is added, the nucleic acid template can be expressed as a peptide or protein using the cell derived expression machinery.

Any particular nucleic acid template can be expressed using the system described herein. Three types of nucleic acid templates used in CFPS include plasmids, linear expression templates (LETs), and mRNA. Plasmids are circular templates, which can be produced either in cells or synthetically. LETs can be made via PCR. While LETs are easier and faster to make, plasmid yields are usually higher in CFPS. mRNA can be produced through in-vitro transcription systems. The methods use a single nucleic acid template per droplet. The methods can use multiple droplets having a different nucleic acid template per droplet.

An energy source is an important part of a cell-free reaction. Usually, a separate mixture containing the needed energy source, along with a supply of amino acids, is added to the extract for the reaction. Common sources are phosphoenolpyruvate, acetyl phosphate, and creatine phosphate. The energy source can be replenished during the expression process by adding further reagents to the droplet during the process.

The cell-free extract having the components for protein expression includes everything required for protein expression apart from the nucleic acid template. Thus the term includes all the relevant ribosomes, enzymes, initiation factors, nucleotide monomers, amino acid monomers, metal ions and energy sources. Once the nucleic acid template is added, protein expression is initiated without further reagents being required.

Thus the cell-lysate can be supplemented with additional reagents prior to the template being added. The cell-free extract having the components for protein expression would typically be produced as a bulk reagent or ‘master mix’ which can be formulated into many identical droplets prior to the distinct template being separately added to separate droplets. Common cell extracts in use today are made from E. coli (ECE), rabbit reticulocytes (RRL), wheat germ (WGE), insect cells (ICE) and Yeast Kluyveromyces (the D2P system). All of these extracts are commercially available.

Rather than originating from a cell extract, the cell-free system can be assembled from the required reagents. Systems based on reconstituted, purified molecular reagents are commercially available, for example the PURE system for protein production, and can be used as supplied. The PURE system is composed of all the enzymes that are involved in transcription and translation, as well as highly purified 70S ribosomes. The protein synthesis reaction of the PURE system lacks proteases and ribonucleases, which are often present as undesired molecules in cell extracts.

Once the CFPS reagents have been enclosed in the droplets, additional reagents can be supplied by merging the original droplet with a second droplet. The second droplet can carry any desired additional reagents, including for example oxygen or ‘power’ sources, or test reagents to which it is desired to expose to the expressed protein.

The droplets can be aqueous droplets. The droplets can contain an oil immiscible organic solvent such as for example DMSO. The droplets can be a mixture of water and solvent, providing the droplets do not dissolve into the bulk filler liquid.

The droplets containing the cell-free extract having the components for protein expression will therefore typically be in the oil filled environment before the nucleic acid templates are added to the droplets. The templates can be added by merging droplets on the microfluidic device. Alternatively, the templates can be added to the droplets outside the device and then flowed into the device for the expression process. For example the expression process can be initiated on the device by increasing the temperature. The expression system typically operates optimally at temperatures above standard room temperatures, for example at or above 29° C.

The expression process typically takes many hours. Thus the process should be left for at least 30 minutes or 1 hour, typically at least 2 hours. Expression can be left for at least 12 hours. During the process of expression the droplets should be moved within the device. The moving improves the process by mixing the reagents and ensuring sufficient oxygen is available within the droplet. The moving can be continuous, or can be repeated with intervening periods of non-movement.

Thus the aqueous droplet can be repeatedly moved for at least a period of 30 minutes or one hour whilst the protein is expressed. The aqueous droplet can be repeatedly moved for at least a period of two hours whilst the protein is expressed. The aqueous droplet can be repeatedly moved for at least a period of twelve hours whilst the protein is expressed. The act of moving the droplet allows mixing within the droplet, and allows oxygen or other reagents to be supplied to the droplet. The act of moving improves the level of protein expression over a droplet which remains static.

The filler fluid in the device can be any water immiscible, non-ionic or hydrophobic liquid. The oil can be mineral oil, silicone oil such as dodecamethylpentasiloxane (DMPS), an alkyl-based solvent such as decane or dodecane, or a fluorinated oil.

A source of supplemental oxygen can be supplied to the droplets. For example droplets or gas bubbles containing gaseous or dissolved oxygen can be merged with the aqueous droplets during the protein expression. Alternatively the source of oxygen can be a molecular source which releases oxygen. Alternatively the droplets can be moved to an air/liquid boundary to enable increased diffusion of oxygen from a gaseous environment. Alternatively the oil can be oxygenated.

The droplet can be formed before entering the microfluidic device and flowed into the device. Alternatively the droplets can be merged on the device. Included is a method comprising merging a first droplet containing a nucleic acid template such as a plasmid with a second droplet containing a cell-free system having the components for protein expression to form the droplet.

The droplets can be split on the device either before, during or after expression. Included herein is a method further comprising splitting the droplet into multiple droplets. If desired the split droplets can be screened with further additives. Included is a method wherein one of more of the split droplets are merged with additive droplets for screening.

Through an affinity tag, such as a FLAG-tag, HIS-tag, GST-tag, MBP-tag, STREP-tag, or other form of affinity tag, CFPS-expressed proteins can be immobilized to a solid-support affinity resin and fresh batches of CFPS reagent can be delivered over the said resin. Thus, renewed reagents can be used to carry out protein synthesis, closely mimicking industrial methods of continuous flow (CF) and continuous exchange (CE) CFPS. By mimicking CF- and CE-CFPS, users can scale up their CFPS production methods.

Droplets can also contain additives to reduce the effects of biofouling on digital microfluidic surfaces. Specifically, droplets containing CFPS components can also contain additives such as surfactants or detergents to reduce the effects of biofouling on the hydrophobic or superhydrophobic surface of a digital microfluidic device (Langmuir 2011, 27, 13, 8586-8594). Such droplets may use antifouling additives such as TWEEN 20, Triton X-100, and/or Pluronic F127. Specifically, droplets containing CFPS components may contain TWEEN 20 at 0.1% v/v, Triton X-100 at 0.1% v/v, and/or Pluronic F127 at 0.08% w/v.

Rather than adding surfactants to the aqueous sample, it is instead possible to add surfactant, such as a sorbitan ester such as Span85 (e.g. Sorbitan trioleate, Sigma Aldrich, SKU 8401240025), to the filler liquid. This has the advantages of enabling CFPS reactions to proceed on-DMF without dilution or adulteration. Additionally, it simplifies the sample preparation procedure for setting up the reactions, increasing the ease of use and the consistency of results. Using 1% w/w Span85 in dodecane allows for dilution-free CFPS reactions on-DMF, as well as dilution-free detection of the expressed non-fluorescent proteins. Other surfactants besides Span85, and oils other than dodecane could be used. A range of concentrations of Span85 could be used. Surfactants could be nonionic, anionic, cationic, amphoteric or a mixture thereof. Oils could be mineral oils or synthetic oils, including silicone oils, petroleum oils, and perfluorinated oils. Surfactants can have a detrimental effect on (1) the CFPS reactions and (2) the efficiency of the detection system (if the detection system involves complementation of a tag and detector). For example, by performing the CFPS reaction on-DMF with oil-surfactant mix, the detection of the expressed protein can also proceed without dilution and without adding aqueous surfactant. It has been shown that surfactants reduce the efficiency of some detection systems, including but not limited to the Split GFP (e.g. GFP11/GFP1-10) system, so removing surfactants from the reagent mix and instead adding them to the oil can be beneficial.

The peptide tag can be attached to the C or N terminus of the protein. The peptide tag may be one component of a green fluorescent protein (GFP). For example the peptide tag may be GFP₁₁ and the further polypeptide GFP₁₋₁₀. The peptide tag may be one component of sfCherry. The peptide tag may be sfCherry₁₁ and the further polypeptide sfCherry₁₋₁₀.

The protein may be fused to multiple tags. For example the protein may be fused to multiple GFP₁₁ peptide tags and the synthesis occurs in the presence of multiple GFP₁₋₁₀ polypeptides. For example the protein may be fused to multiple sfCherry₁₁ peptide tags and the synthesis occurs in the presence of multiple sfCherry₁₋₁₀ polypeptides. The protein of interest may be fused to one or more sfCherry₁₁ peptide tags and one or more GFP₁₁ peptide tags and the synthesis occurs in the presence of one or more GFP₁₋₁₀ polypeptides and one or more sfCherry₁₋₁₀ polypeptides.

Where used herein “and/or” is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

It will further be appreciated by those skilled in the art that although the invention has been described by way of example with reference to several embodiments. It is not limited to the disclosed embodiments and that alternative embodiments could be constructed without departing from the scope of the invention as defined in the appended claims.

### Experimental Details

### Adhesion Promotion

Adding 0.5% v/v Silane A-174 to a 1:1 ratio of isopropanol/water and stirring for 30 seconds formed solution 1. Solution 1 was left to stand for at least 2 hours to fully react and was used within 24 hours. Substrates were immersed in the Solution 1 for 30 minutes, while ensuring the flex strips of the TFT arrays were kept dry. Substrates were removed and air dried for 15 minutes and then cleaned in isopropanol for 15-30 seconds with agitation using tweezers. Substrates were dried with an air gun and stored in a Teflon box for Parylene C coating within 30 hours.

### Parylene Coating

Prepared substrates (silanised and non-silanised) were arranged face up on a rotating stage alongside a clean glass slide within the deposition chamber of a thoroughly clean SCS Labcoter 2 and the chamber was sealed. 50 mg of Parylene C dimer was weighed into a disposable aluminium boat and loaded into the sublimation chamber. The system was sealed and pumped down to 50 milliTorr before liquid nitrogen was added to the cold trap. The system continued to evacuate throughout the deposition process. The sublimation chamber was heated to 175° C. and the heater cycled to maintain a target pressure of 0.1 Torr. The sublimation chamber was connected to the deposition chamber by a pyrolysis zone which was heated to 690° C. at a target pressure of 0.5 Torr. The deposition zone remained at ambient temperature, circa 25° C., and around 50 milliTorr. The system was maintained at temperature and pressure for two hours. The system was allowed to return gradually to ambient temperature over 30-40 minutes before the stage and vacuum pump were turned off and the system vented. The samples were removed from the deposition chamber and the coating thickness verified as circa 100 nm by profilometry.

### Split Methods

Influence of the aspect ratio on the splitting success and daughter droplet properties (accuracy and CV).

Droplets containing 50 M fluorescein were dispensed into an electrowetting device. Droplets of size 12×6 pixels were split into two 6×6 droplets using a lateral motion. The intensity of the post split droplets is plotted in FIG. 11. The post-split droplet sizes show a clear bimodal distribution, confirming that the split is systematically unequal. The overall CV of the droplet intensity of 128 droplets after the split is 32.18%.

The splitting is improved is the droplets are further elongated before splitting. Elongation of the aspect ratio (from 12×6 to 16×4) for split helps in providing uniform split ratio by improving the radius of curvature. FIG. 12 shows the droplet intensity after splitting, and indicates the bimodal distribution is removed. The resulting CV across the array is 5.02% when the drops are 8×4 and 4.94% when resized to 6×6. Thus having the split droplets elongated prior to splitting makes splitting of the droplets more even as it increases tolerance against starting volume variations and compensates for reagent that is not actually actuated as it is part of the meniscus during the split.

1. A method for forming a plurality of droplets on an electrokinetic device, the method comprising taking first droplets and splitting the droplets into multiple evenly sized smaller droplets by moving the droplets in opposing lateral directions, wherein the first droplets are elongated before splitting and the lateral movement is at 90 degrees to the elongated axis such that the ends of the droplet move perpendicular to the elongated axis.

2. The method according to claim 1 wherein the first droplets are rectangular.

3. The method according to claim 2 wherein the smaller droplets are square.

4. The method according to claim 2 wherein each rectangle makes two, three or four smaller droplets.

5. The method according to claim 2 wherein each rectangle makes three smaller droplets.

6. The method according to claim 2 wherein each rectangle makes four smaller droplets.

7. The method according to claim 1 wherein the first droplets are oval.

8. The method according to claim 7 wherein the smaller droplets are circular.

9. The method according to any one preceding claim wherein multiple droplets are split simultaneously.

10. The method according to any one preceding claim wherein the splitting generates an array having equal spacing s₁ along one axis and equal spacing s₂ along a second axis.

11. The method according to any one preceding claim wherein the first droplets are elongated and split into evenly sized smaller droplets, and the split droplets are then elongated and further split into smaller droplets.

12. The method according to claim 11 wherein each first droplet is split at least twice in order to make at least 4 smaller evenly sized droplets from each of the first droplets.

13. The method according to any one preceding claim wherein the final droplets are less than 250 nL in volume.

14. The method according to any one preceding claim wherein the final droplets occupy fewer than 10×10 pixels of the electrokinetic device per droplet.

15. The method according to any one preceding claim wherein the final droplets occupy fewer than 4×4 pixels of the electrokinetic device per droplet.

16. The method according to any one preceding claim wherein the first droplets occupy at least 10×10 pixels of the electrokinetic device per droplet.

17. The method according to any one of claims 1 to 16 for performing droplet based cell-free expression of peptides or proteins, wherein the droplets contain a cell-free system having components for protein expression.

18. The method according to claim 17 wherein the droplets contain a nucleic acid template.

19. The method according to any one preceding claim wherein the electrokinetic device has square electrodes.

20. The method according to any one preceding claim wherein multiple first droplets are formed, each using an actuated meniscus in order to normalise the volume of liquid between the first droplets to be split.
